(19) United States
(12) Patent Application Publication
(10) Pub. No.: US 2006/0127100 A1
(43) Pub. Date: Jun. 15, 2006

(54) Simplified signal regenerator structure

(76) Inventors: Michael Y. Frankel, Baltimore, MD (US); Jeffery C. Livas, Millerville, MD (US)

Correspondence Address: OLDS, MAIER & RICHARDSON, PLLC, PO BOX 20245, ALEXANDRIA, VA, 22320-1245, US

(21) Appl. No.: 11/090,047

(22) Filed: Mar. 28, 2005

Related U.S. Application Data
(60) Provisional application No. 60/634,799, filed on Dec. 10, 2004.

(51) Int. Cl. H04B 10/00

(52) U.S. Cl. 398/158

(57) ABSTRACT

Systems and methods for reconditioning an optical signal by OE (optical-to-electrical) converting the signal, recovering clock and data information and performing 3R reconditioning to reamplify, retime and reshape the converted electrical signal, and EO converting the signal back to the optical domain while the FEC and/or Framing encoding of the optical signal remains intact. An exemplary apparatus may be configured to include a receiver 302 with an optical-to-electrical converter, an electronic distortion estimation and compensation unit 304, an electrical-to-optical converter 308, and a transmitter 310.

### CROSS-REFERENCE TO RELATED APPLICATIONS

This application claims priority under 35 U.S.C. § 119(e) to U.S. Provisional Patent Application No. 60/634,799 filed on Dec. 10, 2004, the disclosure of which is incorporated herein by reference in its entirety.

### FIELD OF THE INVENTION

The present invention involves the field of optical communications, and more particularly, the invention involves transport, switching and OEO nodes in a fiber optic network.

### BACKGROUND OF THE INVENTION

Over the course of a decade, fueled by high demand for bandwidth, optical networks have evolved from simple single-channel SONET regenerator-based links to multi-span, multi-channel optically amplified ultra-long haul systems. Signals propagated on optical fibers degrade with distance due to accumulation of noise and distortions. To maintain signal integrity over considerable distances, conventional systems include nodes spaced along the links to recondition the signal. Since it is generally easier to recondition electrical signals than optical signals, signal conditioning is performed in the electrical domain by performing an optical-electrical-optical conversion (OEO) on the received optical signals. The reconditioning nodes convert optical signals into electrical signals (OE), condition the signals in the electrical domain, and then convert the electrical signals back into optical signals (EO) for further transmission in the network. The signal conditioning involves stripping away the forward error correction (FEC) and framing from the converted electrical signal, amplifying the signal, and performing various signal processing functions. In conventional systems, the signal is then sent through a framer unit and the FEC encoded again before being converted back into an optical signal.

FIG. 1 depicts a conventional OEO transceiver/regenerator 100 for receiving, processing, amplifying and regenerating a signal. The signal is received at receiver section 102 and converted to an electrical signal. The CDR unit 104 (Clock and Data Recovery electrical unit) performs signal processing and signal reconditioning on the electrical signal from the receiver section 102. Conventional OEO transceiver/regenerators 100 have an FEC/de-FEC unit 106 which performs forward error correction (FEC) on signals to be transmitted, and strips away the forward error correction coding (de-FEC) on received signals from the receiver section 102. In recent years the trend has been to incorporate the FEC/de-FEC unit 106 on to the same chip as a Mapper/Framer unit 108, as indicated by the dotted line in FIG. 1.

Performance monitoring in conventional implementations is performed by the deFEC portion of FEC/de-FEC unit 106 and by the Mapper/Framer unit 108 (e.g., a SONET Mapper/Framer digital unit). Typically, deFEC unit 106 counts the number of corrected “1” and “0” bits, based on its coding rules. The Mapper/Framer unit 108 counts B1/B2/B3 parity bits to monitor performance. The Mapper/Framer unit 108 is generally packaged in the form of a single IC, often in conjunction with the FEC/de-FEC unit 106 as mentioned above. Mapper/Framer units for protocols other than SONET generally have similar hardware architectures, but a different set of rules for performance monitoring and framing (e.g., Ethernet, Fibre channel, etc.).

Conventional reconditioning nodes such as the OEO transceiver/regenerator 100 are relatively expensive as compared to other network elements. Various embodiments of the present invention perform OEO conversion and signal conditioning more efficiently than conventional systems, and thus may reduce the relatively high costs that have been associated with OEO transceiver/regenerator nodes.

### SUMMARY OF THE INVENTION

Exemplary embodiments of the invention are drawn to an optical conditioning node for reconditioning optical signals, which has a receiver to receive an optical signal encoded with a frame structure, an OE receiver, an electronic distortion estimation and compensation unit coupled to the OE section, and an EO transmitter unit. In various embodiments the signal is received, processed, and retransmitted without knowledge of the frame structure, for example, the FEC and/or Framer encoding scheme.

### BRIEF DESCRIPTION OF THE DRAWINGS

The accompanying drawings, which are incorporated in and constitute part of the specification, illustrate various embodiments of the invention, and, together with the general description, serve to explain the principles of the invention. In the drawings:

FIG. 1 depicts a conventional OEO transceiver/regenerator for receiving, processing, amplifying and regenerating a signal;

FIG. 2A depicts an exemplary network which implements the present invention;

FIG. 2B several fiber optic pair span segments in a fiber optic circuit which implements the invention.

FIG. 3 depicts some details of circuitry and functionality of a transparent optical conditioning node according to various embodiments of the invention;

FIG. 4 depicts an implementation of the electronic distortion estimation and compensation, and clock and data recovery (EDC-CDR) unit; and

FIG. 5 is a flowchart of a method for practicing various embodiments of the invention.

### DETAILED DESCRIPTION OF THE INVENTION

In describing various embodiments of the invention, specific terminology is used for the purpose of illustration and for the sake of clarity. However, the invention is not necessarily intended to be limited to the specific terminology or particular wording so selected. It is intended that each specific term includes those technical equivalents which operate in a similar manner to accomplish a similar purpose.

One goal of optical system designers is to minimize the bit error rate (BER) of communications so as to improve the overall performance of the system. Forward error correction (FEC) is used to reduce bit error rates by allowing for the correction of errors in the transmission of the data in an effort to improve system performance. The addition of FEC to a signal boosts the effective signal-to-noise ratio (SNR), allowing signals to achieve longer propagation distance and to operate with higher levels of noise and distortion. FEC information is added to the overhead information of a signal. For example, FEC codes may be appended to the electronic wrapper or enveloping scheme of the signal. A typical FEC scheme (e.g., Reed Solomon (RS-code) or Bose Chaudhuri Hocquenghem (BCH-code)) may add from 5% to 10% extra data to the overhead of a signal, and consumes a commensurate amount of processing resources each time the signal is encoded or decoded. Various embodiments allow signals to be transmitted without necessarily incurring the efficiency penalty for FEC coding to be stripped away and then regenerated at each OEO node, or each time an OE conversion is performed.

In general, the cost of a well-designed high capacity optical communication system is dominated by the number of optical-to-electrical (OE) and electrical-to-optical (EO) conversions required. As the reach and channel capacity of the transport systems continues to increase, it becomes increasingly important to be able to efficiently process and condition signals along the transport path, as well as add and drop channels where they are needed. Lately, the industry has been aggressively pursuing a natural extension of this philosophy towards all-optical “analog” core networks, with the demand-touching electrical digital circuitry only at the ingress/egress nodes. The thought behind this trend is that it is expected to produce a substantial elimination of OEO costs, since conventional OEO nodes tend to be relatively expensive in comparison to other network elements. Many believe that an all-optical “analog” core network will help to increase network capacity, and provide a notionally simpler operation and service turn-up.

Although an all-optical analog core network eliminates much of the OEO regeneration cost, such an all-optical analog network generally entails complicated hardware and software for monitoring and manipulating high bit rate optical signals. For example, complex modulation formats may be used to provide resiliency to both optical noise and nonlinear propagation effects, characteristics that are important for extended unregenerated reach. On the hardware side, more sophisticated optical amplifiers provide lower noise for increased reach and increased spectral bandwidth for higher wavelength count and lower wavelength blocking probability. These, and other aspects of all-optical “analog” core networks, tend to drive up costs. Optical analog networks are typically designed with an eye towards mitigating optical power transients, controlling optical spectral flatness, and dynamically managing the effects of dispersion (e.g. in chromatic dispersion, polarization dispersion, modal dispersion). The different forms of dispersion tend to cause optical pulse broadening and inter-symbol interference (ISI) due to the inherent optical properties of the fiber. Propagating signals which stay solely in the optical domain without OEO regeneration may require optical performance monitoring techniques for fault isolation and correction. Efficient routing of optical signals in the analog optical domain may entail sophisticated switching nodes with an ability to selectively steer optical signals into several directions with single-channel spectral granularity.

Most of the above-mentioned technologies used in all-optical analog core networks are not modular, and therefore may require interruption of service if not deployed at the initial system installation. This may substantially increase the installation costs if the all-optical analog network equipment is not initially deployed, even if the initial capacity loading is small. Further, lab testing and validation of systems and software targeting a specific network design tends to be very complex. Only a small fraction of the total network may reasonably be reproduced in the lab, and many field configurations are not predictable and may be even dynamic. Thus, extra system margin has to be allocated to handle the behavioral uncertainty of an all-optical analog network. Various embodiments may be implemented to reduce the complexity of both hardware technology and software algorithms, establishing smaller regions of network transparency with OEO forced at the perimeters. Thus, by implementing various embodiments “analog” regions are created, surrounded by “digital” OEO interfaces. The cost of the fiber-optic network and its complexity may be substantially reduced with the introduction of more frequent, inexpensive OEO regenerators in accordance with various embodiments of the invention.

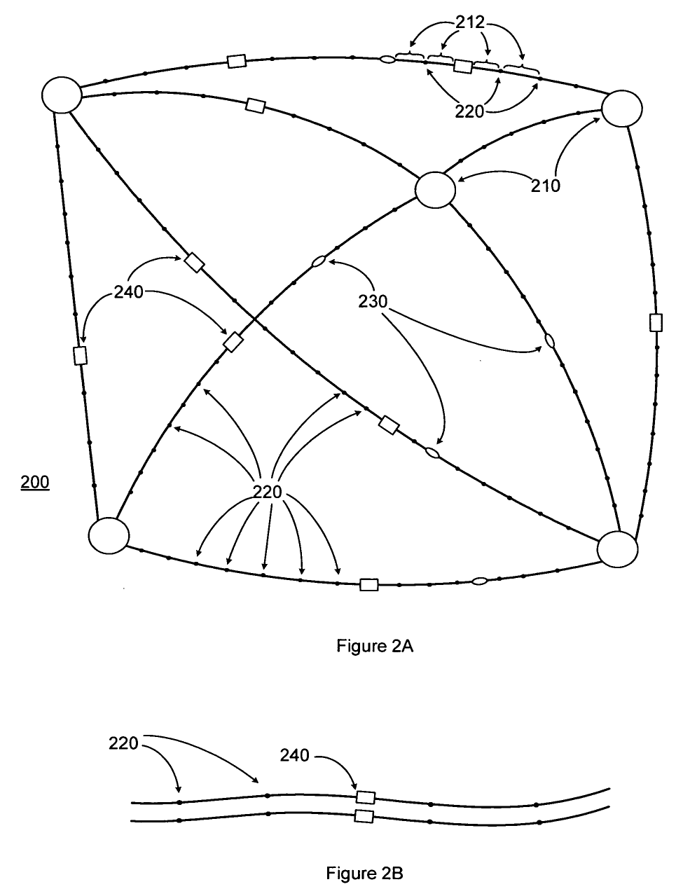

FIG. 2A depicts an exemplary optical network 200 which implements the present invention. The optical network 200 may represent a long haul network primarily for connecting ingress/egress points across vast distances, or may be a short haul metropolitan network, or a combination of both. The optical network 200 includes a number of end terminals 210, sometimes known in the art as simply network elements. The optical network 200 may also include Optical Add/Drop Multiplexers 230 (OADMs). The end terminals 210 and OADMs 230 are client interface nodes which serve as ingress/egress points for introducing signals into or retrieving signals from the optical network 200. The data introduced at end terminals 210 and 230 may include, for example, either real-time or delayed data comprising Internet traffic, encoded telephone communications, television signals, audio, video, characters representing information, or any of a myriad other such data subject to transport via optical signals. Any of a number of modulations schemes may be used on the optical signals including phase shift keying (PSK), intensity modulation (IM), or other like schemes. Optical data signals transmitted via optical network 200 typically include a number of different wavelengths, with each different wavelength offering the possibility to serve as a different optical communication channel. As such, optical communication systems such as the optical network 200 generally support many optical channels each of which transmit via a different optical carrier wavelength. The most common optical carrier wavelengths tend to be in the range of 1530 nm to 1565 nm. However, embodiments may be implemented in any light-frequency range capable of carrying optical signals. The optical network 200 may be a multiplexed network, such as a wavelength division multiplexing (WDM) network or a dense wavelength division multiplexing (DWDM) network, in which many different signals are simultaneously propagated through a single one of the optical fibers 212.

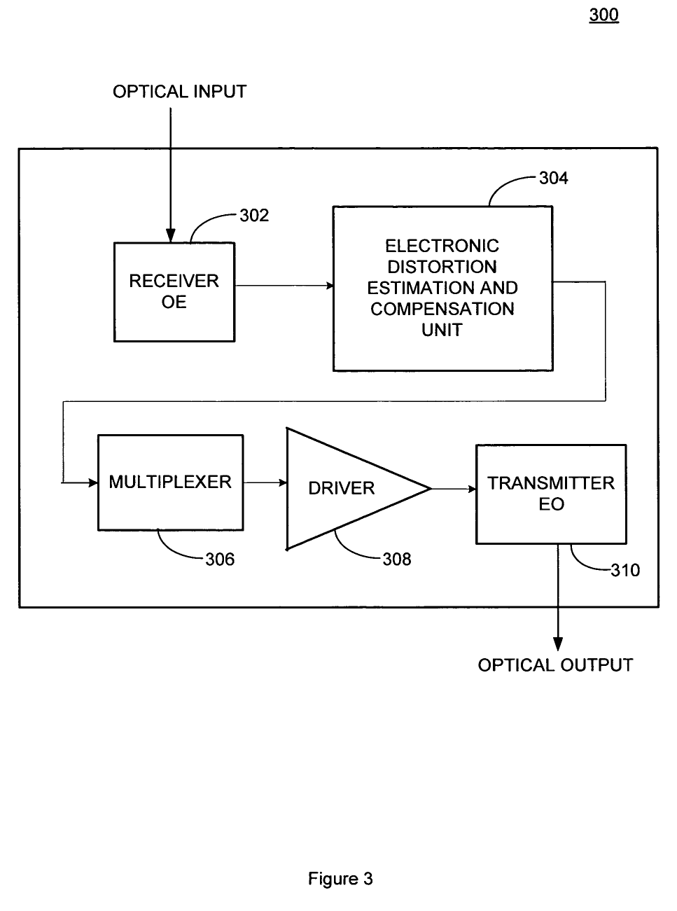

Each client interface node 210 or 230 may be configured to include one or more EO interfaces to transform electrical signals into optical signals for sending the signal, in optical format, to another destination client interface node 210 or 230 via the optical network 200. The client interface nodes 210 and 230 are nodes at which client signals may be introduced from outside the optical network, converted into optical signals appropriate for the designed network 200, and sent along their way through the optical network 200. Similarly, optical signals received through the optical network 200 may be provided to clients via client interface nodes 210 and 230. To achieve this each client interface node 210 and 230 includes one or more optical transmitters and optical receivers, for example, akin to 310 and 302 of FIG. 3 discussed below. Optical transmitters convert electrical data signals to optical data signals for transmission over optical fibers 212 toward a destination client having its own optical receiver on the optical network 200. Optical receiver elements, on the other hand, reconvert received optical data signals into electrical signals.

The nodes and network elements of the optical network 200 are interconnected with spans of optical fiber 212. The various optical fibers 212 interconnecting the optical network 200 may either be multi-mode fiber (MMF) or single-mode fiber in the form of any optical media or material capable of propagating optical signals between two points. Some networks may be designed to have spans propagating light signals in both directions within the same optical fiber. However, network elements such as those of optical network 200 are typically interconnected with pairs of optical fiber 212, and sometimes bundles of fibers, with each fiber propagating signals in only one direction. In other words, the routes between terminal nodes 210 often include two or more optical fibers which interconnect network elements (e.g., amplifiers 220, OADMs 230, optical conditioning nodes 240), but may comprise one or more unidirectional fibers or bidirectional fibers or a combination of both. For the sake of illustrative simplicity, FIG. 2A shows a single line interconnecting the various network elements, the single line representing one or more optical fibers which interconnect the network elements. In practice the routes between the client interface nodes 210 and 230 generally have at least a pair of optical fibers, as shown in FIG. 2B.

The spans of optical fiber 212 between elements of the network 200 are often on the order of 40 to 120 km in length, but may be any length suitable for the application (e.g., long haul, metro, etc.). The parameters and optical characteristics of the materials in optical fiber 212 may depend on the specific application, too. Networks such as the optical network 200 may vary greatly in the distances covered, the number and types of nodes, as well as the communication protocols used to convey information, for example, SONET, SDH, OTN, GFP, Ethernet, ATM, or other like protocols. Light signals propagating down the optical fiber 212 are subject to attenuation and distortion. To increase the power level of the signals optical networks such as the optical network 200 generally have optical amplifiers 220 or other such gain elements spaced every so far along the optical fiber 212 (e.g., 40 km to 120 km).

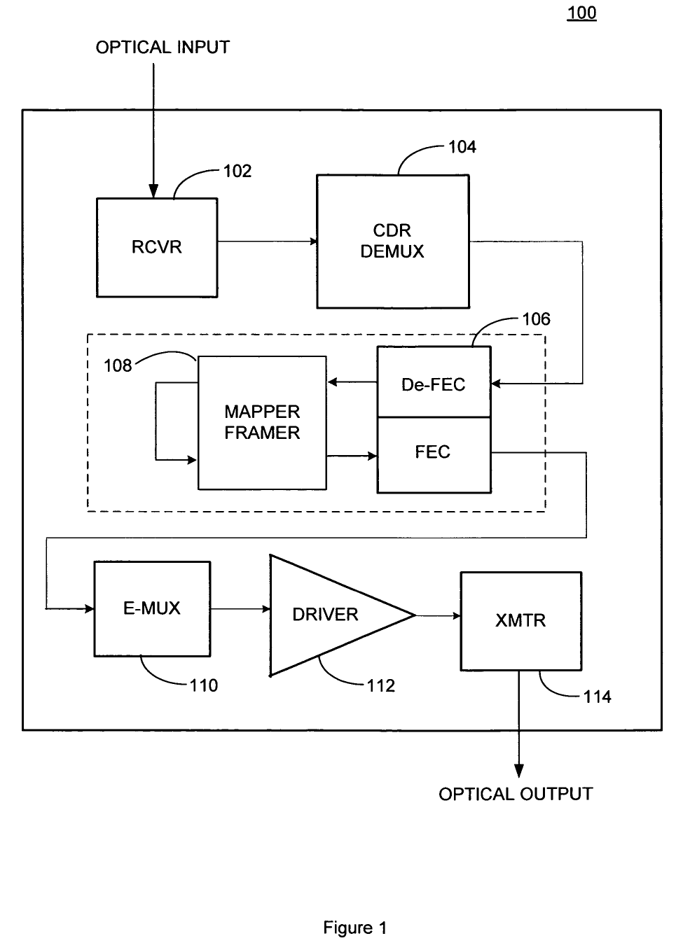

One drawback of amplifiers 220 is that they tend to amplify the noise and distortion characteristics of the signal along with the signal itself. So as the signal propagates down a route through optical fiber span segments 212 and is amplified by a number of amplifiers 220 the quality of the signal tends to deteriorate. At some juncture it becomes desirable to recondition the signal by converting the optical signal into the electrical domain. In the past, systems have done this with conventional OEO transceiver/regenerator nodes such as the one depicted in FIG. 1. However, the conventional OEO transceiver/regenerator nodes 100 tend to be relatively expensive and are subject to certain drawbacks and constraints. For example, conventional OEO transceiver/regenerator nodes 100 are subject to the drawback of not being bit-rate transparent. As such, they are tied to a particular bit rate and are not adept at processing signals at other rates. Further, conventional OEO transceiver/regenerator nodes 100 are not protocol transparent since they are limited to handling signals of a particular protocol. Protocol transparency is sometimes known in the art as being protocol agnostic. Various embodiments of the invention overcome either, or both, of these drawbacks.

Various embodiments of the invention are bit-rate transparent. As such they are not tied to a particular bit rate, and instead may transmit data at bit rates of up to 15 gigabits/sec, or more. With the advent of increased circuitry switching speeds, embodiments may be practiced at bit rates of 45 gigabits/sec or more. Various embodiments of the invention are also protocol transparent. As such they are not tied to a particular frame structure. The frame structure may entail the FEC scheme or protocols such as SONET, SDH, OTN, GFP, Ethernet, ATM, or other like protocols. The various protocol transparent embodiments, since they are not tied to any particular encoding scheme or protocol, are not constrained to operate with a particular frame structure. Moreover, various embodiments may be configured to be protocol nescient in that they are protocol transparent (that is, can handle signals of various protocols) and further, they do not know, or need to know, what particular frame structure has been used to encode, package, envelop and/or propagate the signal. In embodiments of the invention, optical conditioning nodes 240 are provided as elements in network 200 to recondition and amplify the signal by converting it from the optical domain into the electrical domain and back to the optical domain again. A further explanation of optical conditioning nodes 240 is provided below in conjunction with a depiction of an exemplary transparent optical conditioning node in FIG. 3.

In order to add and/or drop signals in the optical domain, the optical network 200 often has one or more OADMs 230 (optical add/drop multiplexers) interspersed throughout the network. It improves the granularity of demand connections to incorporate OADMs as needed to add and drop channels in the optical domain. If a node requires only small client demand connectivity, most of the optical channels received by the OADM 230 are expressed through without OEO regeneration and signal conditioning. In this way the signals expressed through the OADM 230 are not converted out of the optical domain and the network costs can be correspondingly reduced, thus partially balancing out the increased cost of the OADM 230 nodes. Each OADM 230 has the ability to separate channels at predefined specific wavelengths from the optical data signal it receives, or add channels at the same or other predefined wavelengths to the optical data signal transmitted by the OADM 230.

An optical network 200 suitable for implementing various embodiments of the invention may be configured and interconnected in myriad different ways, with various combinations and numbers of the different types of nodes, e.g., terminal nodes 210, amplifiers 220, OADMs 230, optical conditioning nodes 240. One situation in which embodiments are likely to be most applicable arises when there is a lengthy route containing enough amplifiers to result in signal quality deterioration to the point where regeneration of the signal becomes desirable. But a lengthy route may not be the only situation in which it is appropriate to implement one or more embodiments of the invention. Embodiments are appropriately implemented in nearly any situation or conditions in which optical signals are subject to degradation, for example, routes subject to adverse environmental conditions, points which empirically indicate problems with signal deterioration, or the like. Typically the optical conditioning nodes 240 in an optical network reduce signal noise and distortion, often by performing 3R (Re-amplify, Re-shape and Re-time) functionality on the signal. One or more of the optical conditioning nodes 240 may also be configured to provide data or signal quality monitoring functionality for network fault isolation and protection switching mechanisms.

FIG. 3 depicts some details of circuitry and functionality present in a transparent optical conditioning node according to various embodiments. The circuitry and functions of the optical conditioning unit 300 depicted in FIG. 3 may be packaged in various forms, with portions implemented as hardware, software, firmware, or a combination of these. An optical fiber 212 entering an optical conditioning node 240 may carry a multiplexed optical signal (e.g., WDM or DWDM) consisting of many different individual optical signals. The optical conditioning node 240 may either be configured to contain one set of circuitry, such as conditioning unit 300, dedicated to each of the many different signals in the multiplexed signal received at the node, or may contain one or more conditioning units 300 which each process a plurality of the many different signals.

Regarding FIG. 3, an optical signal is received at the optical conditioning unit 300 by the receiver 302. The receiver 302 typically has an analog front end and may be configured to perform an OE conversion on the received light signal. The OE conversion is generally performed by a photodetector with the receiver 302 which converts the optical signal into a photocurrent or electrical signal. In addition to the photodetector, receiver 302 may also include circuitry and/or software or logic to perform functions such as those of an amplifier, one or more filters, and sometimes may include aspects of timing recovery. Depending upon the particular details of the implementation, one or more of these functions may be performed elsewhere in the optical conditioning unit 300. For example, the amplifiers, ADC, filters and/or timing recovery may also be performed in the electronic distortion estimation and compensation unit 304. The receiver 302 converts the received optical signals into electrical signals using circuitry and methods known to those of skill in the art. The receiver 302 provides the signal in electrical form to the electronic distortion estimation and compensation unit 304.

Since various embodiments are protocol transparent it is typically not necessary for a FEC/de-FEC unit (such as unit 106 of FIG. 1) which strips away the forward error correction coding (de-FEC function) of the received signals. Instead, some embodiments have the electronic distortion estimation and compensation unit 304 directly coupled to the transmit portion of the conditioning unit 300. By “directly coupled” it is meant that the electronic distortion estimation and compensation unit 304 provides the electrical signal to the transmit portion without any intervening de-FEC function such as that performed in the FEC/de-FEC unit 106, and/or without any Mapper/Framer function such as performed by the Mapper/Framer unit 108 of the conventional device illustrated in FIG. 1. The electronic distortion estimation and compensation unit 304 may still be considered “directly coupled” to the transmit portion even though there may be intervening interfaces or other such circuitry, so long as the intervening circuitry does not include a de-FEC function and Mapper/Framer function that takes place between the electronic distortion estimation and compensation unit 304 and transmit portion.

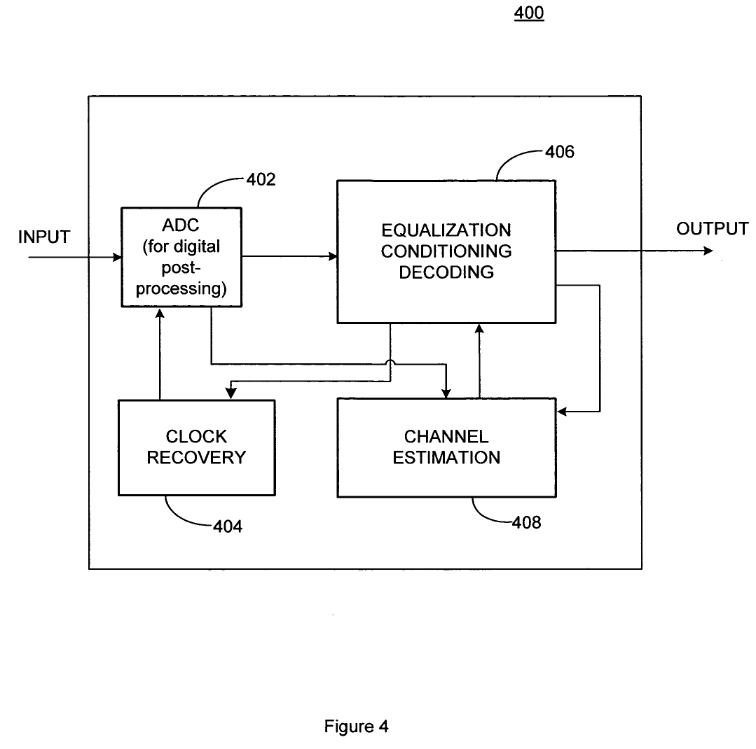

The electronic distortion estimation and compensation unit 304 may be configured to demultiplex the received signal, now in electronic form, into a plurality of lower bit-rate signals to reduce the processing complexity of dealing with high-speed electronic signals. The electronic distortion estimation and compensation unit 304 may also be configured to either perform clock and data recovery functions (CDR), or else contain a CDR section for clock and data recovery. Alternatively, the CDR functions may be performed elsewhere within the optical conditioning unit 300 and communicated to the electronic distortion estimation and compensation unit 304. The electronic distortion estimation and compensation unit 304 typically is configured to perform 3R functionality on the electrical signal from the receiver 302 to re-amplify, re-shape and re-time the signal. The OEO 3R functionality of the electronic distortion estimation and compensation unit 304 may be implemented in many physical forms, including for example, an IC, an ASIC, or other such packages of circuitry, or by using a combination of hardware, software, firmware, or the like. For example, the 3R functionality of the of the electronic distortion estimation and compensation unit 304 may be implemented in the form of an integrated circuit such as one of the next generation of “smart” ICs which perform clock and data recovery (CDR) and electronic distortion compensation (EDC) as depicted in FIG. 4. Such EDC-CDR ICs perform the EDC function by correcting a range of signal distortion due to signal propagation. EDC may be performed through adaptive filtering techniques. For example, EDC may be achieved using finite impulse response (FIR) techniques in which the signal is fed through a bank of filters, each filter being weighted and having a time delay associated with it. In this way components of the signal may be reordered and reprioritized to perform the inverse function of the dispersion affects the signal was subjected to. An advantage of using FIR filtering is that the filtering coefficients may be chosen by adaptive algorithms so as to conform to present conditions in compensating for the distortion effects of the fiber.

Another benefit of the electronic distortion estimation and compensation unit 304 is that it may be configured to provide a quality of signal (QOS) measurement which is suitable for use in system management purposes. In embodiments with QOS measurement, the electronic distortion estimation and compensation unit 304 produces error signals that may be used in closed loop control of circuitry within the electronic distortion estimation and compensation unit 304 itself, or the error signals may be used for overall transmission diagnostics. In accordance with various embodiments the electronic distortion estimation and compensation unit 304 may be used in an open loop configuration without the framer. In this way, embodiments with QOS measurement may be used directly to provide functions of fault isolation and mitigation in the networks akin to those performed in conventional systems by the Framer and/or FEC error counters.

The QOS signals are intrinsically available from configurations of the electronic distortion estimation and compensation unit 304. For example, in case of analog filter implementation, the coefficients loaded into the filter and adjusted to reach an optimal filtering function provide a measure and type of signal distortion and noise. In case of a digital filter, algorithms such as Maximum Likelihood Sequence Estimation (MLSE) also provide a measure of signal distortion and noise. Depending on the accuracy and stability of the QOS signal, it may be used two ways. If QOS signal accuracy is insufficient, the QOS signal may be used as a relative indicator—a QOS baseline may be measured at a time the signal is in a known good state. If the QOS signal deviates from the established baseline by a predetermined range, that deviation would indicate signal degradation of failure. If QOS signal accuracy is good, then it may be used directly without establishing relative baselines. If QOS degrades to a specific value or setting, that value would directly indicate a corresponding signal degradation or failure.

Various embodiments of the invention may significantly reduce the network penalty of OEO regeneration due to cost, size, and power consumption. This is accomplished in the various embodiments by eliminating the FEC and/or Mapper/Framer ICs from the OEO regenerators, the optical conditioning units 300. With these functions removed from the optical conditioning nodes 240 of the exemplary embodiment illustrated in FIG. 2A, for example, the FEC and Mapper/Framer functions need only be present at the client interface nodes 210 and 230. On the circuits depicted in FIG. 2 between the various pairs of client interface nodes 210 and 230, many, if not all, of the FEC and Mapper/Framer ICs in the OEO regenerators and nodes throughout the optical network 200 may be eliminated, thus reducing system costs. An added benefit is that removing the FEC/Framer from various embodiments also removes the bit-rate and signal FEC and framing format constraints. This makes the devices bit-rate transparent and protocol transparent, respectively, so that any signal with a data rate that can be captured by the CDR function within the electronic distortion estimation and compensation unit 304 will be regenerated, regardless of the frame structure. As such, an enhanced level of format transparency is provided in the network since the regeneration function may be decoupled from knowledge of particular signal protocol or Framing structure.

Once the electronic distortion estimation and compensation unit 304 has performed 3R functionality, reconditioning the electrical signal, the signal may be passed to an e-mux 306 before being provided to driver 308, an electrical-to-optical converter of the optical conditioning unit 300. The driver 308 drives a laser/modulator 310, which may be referred to as an optical transmitter, for outputting the reconditioned signal.

FIG. 4 depicts a typical configuration for an electronic distortion compensation/clock and data recovery (EDC-CDR) unit 400 which may be used to implement the functionality of electronic distortion estimation and compensation unit 304. A signal at the input of the EDC-CDR unit 400 may be fed to an analog front end (not shown) for OE conversion and amplification of the signal. The equalization conditioning and decoding unit 406 may be implemented in a variety of ways to estimate signal distortion and condition the signal. For example, unit 406 may be implemented as analog circuitry such as FIR filter, Infinite Impulse Response (IIR) filter, a feed-forward equalizer, a decision-feedback equalizer, or some combination of the above filters. As another example, the equalization conditioning and decoding unit 406 may be implemented as a digital filter or processor, which may entail adding an analog-digital-converter (ADC) function such as would be performed in the ADC unit 402. Alternatively, the ADC function may be performed outside of the EDC-CDR unit 400, depending upon the particular implementation being used. The EDC-CDR unit 400 typically includes clock and data recovery circuitry such as the clock recovery unit 404 shown in the figure. A clock recovery unit 404 may receive a reference clock input signal (not shown) for use in recovering the timing of the signal received by the EDC-CDR unit 400. The clock recovery unit 404 provides a clock signal to the ADC unit 402, and to the equalization conditioning and decoding unit 406.

The equalization conditioning and decoding unit 406, with the clock signal from 404 and a channel estimate from 408, performs signal conditioning, equalization and decoding on the signal it receives from the ADC 402. The equalization conditioning and decoding unit 406, in turn, provides a feedback loop to the channel estimation unit 408, and outputs the reconditioned signal, for example, to circuitry within the optical conditioning unit 300. Since the signal received at the EDC-CDR unit 400 is often very high speed, the EDC-CDR unit 400 may be configured to include a demultiplexer to divide the signal into a plurality of lower bit-rate signals to aid in signal conditioning and processing. In embodiments in which the signal is demultiplexed for signal conditioning purposes, the signal must again be recombined using a multiplexer such as the multiplexer 306 depicted as part of optical conditioning unit 300 in FIG. 3.

An optical conditioning module for reconditioning optical signals according to embodiments herein may include a receiver unit, an optical-to-electrical conversion section, an electronic distortion compensation unit, an electrical-to-optical conversion section, and a transmitter. The receiver unit is configured to receive a received optical signal encoded with a frame structure. The optical-to-electrical conversion section coupled to the receiver unit is configured to convert the received optical signal into an electrical signal still being encoded with the frame structure. The electronic distortion compensation unit, which is coupled to the optical-to-electrical conversion section, is configured to recondition the electrical signal still encoded with the frame structure. Then the electrical-to-optical conversion section, which is coupled to the electronic distortion compensation unit, is configured to convert the electrical signal back into a reconditioned optical signal. Finally, the transmitter unit, which is coupled to the electrical-to-optical conversion section, transmits the reconditioned optical signal which remains encoded with said frame structure.

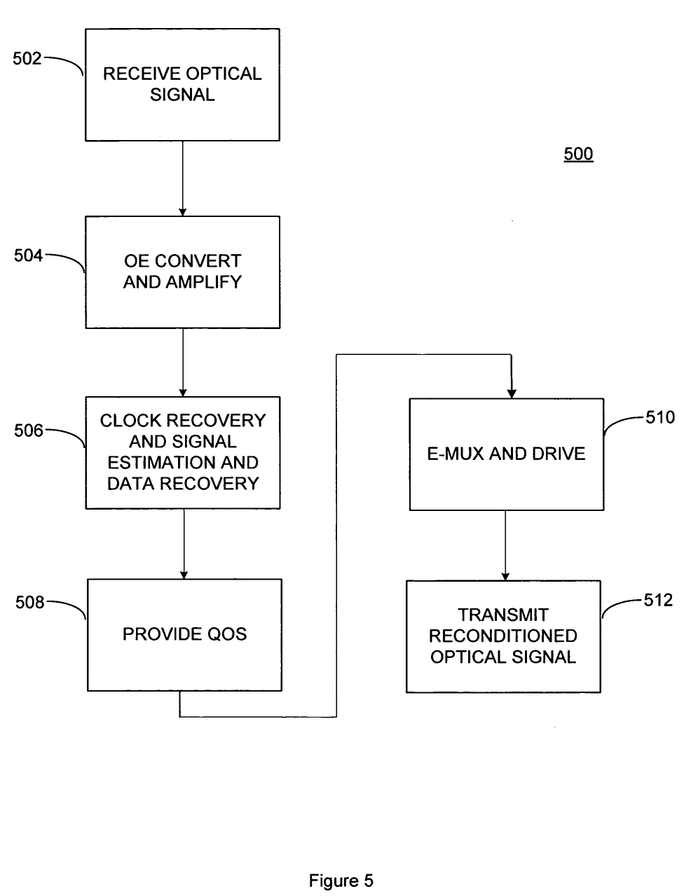

FIG. 5 depicts a method for practicing at least one embodiment of the invention. The method begins at step 502 with the reception of an optical signal transmitted via a fiber optic cable. The optical signal may be received by an optical receiver such as receiver 302 depicted in FIG. 3. Typically, optical signals contain some sort of error encoding or error detection/recovery scheme. Forward Error Correction (FEC) is commonly used in optical communications. The error detection scheme may entail any type of routine or algorithm which may be used in fiber optic communications or derivatives of schemes used in other communication media. Such error schemes may include, for example, a redundancy check or cyclical redundancy check (CRC), a frame check sequence (FCS), or schemes based on error correction codes (ECC) such as Hamming code, Reed-Solomon code, Reed-Muller code, Binary Golay code, convolutional code, turbo code, or other like type of error detection or error recovery schemes. The term FEC, as used herein, applies to any such error detection or recovery schemes suitable for use in optical communications.

The method progresses to 504 where the optical signal is OE converted from an optical signal to an electrical signal. In practice a photodetector or a plurality of photodetectors within the receiver 302 are often used to convert the light signal into an electrical signal. At this point following the photodetector, in some embodiments the electrical signal is a current signal which is then converted to a voltage signal, for example, using a preamplifier such as a trans-impedance amplifier (TIA). The OE and amplification functions are typically performed within the optical receiver 302 of FIG. 3, but in other implementations may take place within another assembly in the optical conditioning unit 300. Once the signal has been OE converted and amplified in accordance with 504, the signal, now in electrical form, is typically subjected to reconditioning in an electronic distortion estimation and compensation (e.g., using unit 304 or other logic within optical conditioning unit 300). The reconditioning involves some manner of signal processing, one aspect of which is the clock and data recovery of block 506.

It should be noted that, in various embodiments of the invention the FEC and/or Framing coding are not stripped from the electrical signal as it is passed through the receiver and processed by the EDC-CDR unit. Since the FEC and/or Framing coding are not stripped from the signal, these various embodiments do not require circuitry for a FEC/de-FEC function or for Framing function (or other error detection scheme) in the optical conditioning unit 300. Instead, the optical signal is received, OE converted, processed and reconditioned, and then converted back in optical form, all while the received frame structure remains intact. In this context “received frame structure” is intended to mean the FEC coding and/or Framing coding of the signal when it is received by the optical conditioning unit 300. In these embodiments the received frame structure is not stripped away from the received signal as it is processed through the optical conditioning unit 300 and reconditioned. Accordingly, the reconditioned optical signal, which is transmitted from the optical conditioning unit 300 still includes the received framing structure, e.g., the received FEC and Framing coding.

The method proceeds to 506 where the clock is recovered and the signal distortion parameters are estimated and data is recovered based on the estimated parameters. For the sake of clarity, the term “signal” is used herein to refer to the signal—or plurality of signals if demultiplexing takes place—corresponding to the received optical signal even though the “signal” may have been demultiplexed into a number of component signals. In 506 the signal, in electrical form, is reamplified, reshaped and retimed as the electronic distortion estimation and compensation unit 304 performs 3R functionality on the electrical signal. The signal may be reshaped using a technique akin to an adaptive filtering technique, e.g., FIR filtering using a bank of filters. Other techniques or apparatus known to those of ordinary skill in the art may be used to perform one or more of the 3R functions to recondition the signal. The block 506 may also entail performing distortion estimation on the received signal. Once the signal has been reconditioned in block 506, the method proceeds to 508. In block 508 a QOS measurement may be taken to aid in system management and signal reconditioning or recovery down the line. In some embodiments the QOS measurement is appended to the signal, or envelope, for in-band system management and diagnostic purposes, or it may be carried by a separate communication channel. Typically this is done by using error signals produced by the electronic distortion estimation and compensation unit 304 itself. The electronic distortion estimation and compensation unit 304 is used in an open loop configuration without the framer. In these configurations the QOS indication produced by the EDC-CDR element is used to directly provide system fault isolation/mitigation functions. Since the FEC coding is not stripped from the signal and the signal is not deframed and reframed, the process 500 may be format and/or bit-rate transparent. That is, the regeneration function may be decoupled from a particular signal protocol, framing structure or data rate. This transparency tends to reduce network resources devoted to OEO regeneration, and makes network more adaptable to support possible protocol changes or evolution.

After a measure of QOS has been obtained, the method proceeds from 508 to 510 where the signal is optionally multiplexed and provided to drive circuitry. In block 512 the signal is EO converted by having the drive circuitry drive a laser or a modulator, thus converting the signal back to the optical domain. With the signal in the format of a light signal, the reconditioned signal may be directed down an optical conduit such as the optical fiber 312.

An exemplary method of reconditioning an optical signal according to various embodiments may include receiving an optical signal encoded with a frame structure, and converting the optical signal to an electrical signal while it remains encoded with the frame structure. Electronic distortion compensation is performed on the electrical signal encoded with the frame structure, and the electrical signal encoded with said frame structure is converted into a reconditioned optical signal encoded with said frame structure. Then the reconditioned optical signal may be transmitted, still being encoded with the frame structure.

The figures included herein are provided to explain and enable the invention and to illustrate the principles of the invention. Some of the activities for practicing the invention shown in the method block diagrams of the figures may be performed in an order other than that shown in the figures, or in some configurations may optionally be omitted altogether. For example, block 504 pertains in part to the amplification of the signal. However the signal may also, or alternatively, undergo amplification as part of other blocks described above, for example, in any of 506 through 512. Similarly, the measuring and appending of a QOS indication described in conjunction with block 508 is an optional activity which may not be present in some embodiments.

Those of ordinary skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Those ordinary skilled in the art will also appreciate that the various illustrative logical blocks, modules, circuits, and algorithm routines described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Practitioners of ordinary skill in the art will know to implement the described functionality in ways tailored to suit each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, computer or state machine. A processor may also be implemented as a combination of computing devices, e.g., a combination of a DSP and a microprocessor, a plurality of microprocessors, one or more microprocessors in conjunction with a DSP core, or any other such configuration.

The activities of methods, routines or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor in such a manner that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. Various modifications to the illustrated and discussed embodiments will be readily apparent to those of ordinary skill in the art, and the principles defined herein may be applied to other embodiments without departing from the spirit or scope of the invention. Thus, the present invention is not intended to be limited to the embodiments shown herein but is to be accorded the widest scope consistent with the principles and novel features disclosed herein.

In describing various embodiments of the invention, specific terminology has been used for the purpose of illustration and the sake of clarity. However, the invention is not intended to be limited to the specific terminology so selected. It is intended that each specific term includes equivalents known to those of skill in the art as well as all technical equivalents which operate in a similar manner to accomplish a similar purpose. Hence, the description is not intended to limit the invention. The invention is intended to be protected broadly within the scope of the appended claims. Although the invention has been illustrated by reference to specific embodiments, it will be apparent to those skilled in the art that various changes and modifications may be made which clearly fall within the scope of the invention. The above description illustrates various embodiments of the invention, but, for the sake of clarity, does not provide a detailed explanation of each of the various changes and modifications which fall within the scope of the invention. Hence, the description is not intended to limit the invention. The invention is intended to be protected broadly within the scope of the appended claims.

What is claimed is:

1. An apparatus for compensating an optical signal, the apparatus comprising:
a receiver being configured to receive an optical signal;
an optical-to-electrical converter being coupled to the receiver and being configured to convert the optical signal into an electrical signal;
a compensator being coupled to the optical-to-electrical converter and being configured to compensate the electrical signal;
an electrical-to-optical converter being directly coupled to the compensator and being configured to convert the compensated electrical signal to a compensated optical signal; and
a transmitter being coupled to the electrical-to-optical converter and being configured to transmit the compensated optical signal.

2. The apparatus of claim 1, further comprising a clock and data recovery unit.

3. The apparatus of claim 1, wherein the clock and data recovery unit is configured as part of the compensator; and
wherein the compensator is configured to perform distortion estimation on the optical signal.

4. The apparatus of claim 2, wherein the compensator is configured to reamplify, retime and reshape the electrical signal.

5. The apparatus of claim 1, wherein the compensator is configured to perform adaptive filtering.

6. The apparatus of claim 1, wherein the optical-to-electrical converter is configured as part of the receiver.

7. The apparatus of claim 1, wherein the apparatus is protocol transparent.

8. The apparatus of claim 1, wherein the apparatus is bit-rate transparent over a predefined frequency range.

9. The apparatus of claim 8, wherein the predefined frequency range comprises frequencies less than 15 gigabits/sec.

10. The apparatus of claim 1, wherein the optical signal is received via a first span of optical fiber from a first optical amplifier; and
wherein the reconditioned optical signal is transmitted via a second span of optical fiber to a second optical amplifier.

11. The apparatus of claim 3, wherein the compensator is configured to provide a quality of signal (QOS) measurement.

12. A method of conditioning an optical signal comprising:
receiving the optical signal;
converting the optical signal to an electrical signal;
performing electronic distortion compensation on the electrical signal;
converting the electrical signal into a reconditioned optical signal; and
transmitting the reconditioned optical signal.

13. The method of claim 12, further comprising:
recovering clock and data information from the optical signal; and
performing distortion estimation on the optical signal.

14. The method of claim 13, further comprising:
reamplifying, retiming and reshaping the electrical signal as part of the performing electronic distortion compensation.

15. The method of claim 13, further comprising:
adaptively filtering the electrical signal as part of the performing electronic distortion compensation.

16. The method of claim 13, wherein the method is protocol transparent.

17. The method of claim 13, wherein the method is bit-rate transparent over a predefined frequency range.

18. The method of claim 17, wherein the predefined frequency range comprises frequencies less than 15 gigabits/sec.

19. The method of claim 12, further comprising:
receiving the optical signal via a first span of fiber optic cable from a first optical amplifier; and
transmitting the reconditioned optical signal via a second span of fiber optic cable to a second optical amplifier.

20. The method of claim 13, further comprising:
providing a quality of signal (QOS) measurement.

21. An apparatus for compensating an optical signal, the apparatus comprising:
a receiver being configured to receive a received optical signal encoded with a frame structure;
an optical-to-electrical converter being coupled to the receiver and being configured to convert the received optical signal into an electrical signal which remains encoded with said frame structure;
a compensator being coupled to the optical-to-electrical converter and being configured to compensate the electrical signal;
an electrical-to-optical converter being directly coupled to the compensator and being configured to convert the compensated electrical signal to a compensated optical signal which remains encoded with said frame structure; and
a transmitter being coupled to the electrical-to-optical converter and being configured to transmit the compensated optical signal which remains encoded with said frame structure.
